(19) United States
(12) Patent Application Publication
(10) Pub. No.: US 2003/0168082 A1
(43) Pub. Date: Sep. 11, 2003

(54) Injector needle cleaning device

(76) Inventors: Curtis J. Cundith, Wichita, KS (US); Timothy A. Whitman, Goddard, KS (US); Thomas McLaughlin, Wichita, KS (US)

Correspondence Address: Jason R. Kraus, DORSEY & WHITNEY LLP, Suite 1500, 50 South Sixth Street, Minneapolis, MN, 55402-1498, US

(21) Appl. No.: 10/094,410

(22) Filed: Mar. 8, 2002

(51) Int. Cl. B08B 9/00

(52) U.S. Cl. 134/21; 134/30; 134/22.18; 134/95.1; 15/304; 134/166 R

(57) ABSTRACT

A device and method is disclosed for cleaning a plurality of injection needles having a hollow tubular body of a generally constant outer diameter, a proximal opening, and a distal opening. The device includes a housing defining a manifold. The housing has a plurality of corresponding openings through a top and a bottom surface. The openings have a diameter approximately equal to the needle diameter. The device further includes a high-pressure air source coupled to the housing and in fluid communication with the manifold. The method includes inserting needles into the openings, such that a proximal opening of the needle is located within the manifold, and injecting air into the manifold and through the bore of the needles.

### BACKGROUND OF THE INVENTION

The present invention relates to a device and method for cleaning multiple injection needles. More particularly, it relates to a method and device for rapidly cleaning multiple injection needles simultaneously.

Prior to packaging and delivering to the consumer, various cuts of red meat from red meat slaughter animals (including bovine, porcine and ovine) are injected for various purposes, such as tenderizing the meat, adding flavor to the meat, and affecting the coloring of the meat. Various substances are typically injected into the cuts of meat using a needle having a hollow tubular body and having a pointed tip and an entrance orifice and an exit orifice. During use, these needles often become contaminated with fibers from the cuts of meat during the injection process. If these fibers are not removed from the needle, a build-up of fibers can occur and lead to clogged needles and bacterial growth inside the needle. Likewise, if the needle is not properly cleaned, cross-contamination of cuts of meat can occur, when a needle contaminated from a first cut of meat is used to inject a second cut of meat.

These injection needles are currently cleaned by coupling the injection needle to a source of high pressure air and blowing all contaminants out the needle tip. This operation is typically performed one needle at a time, which is inefficient and time consuming. There is need in the art for an injection needle cleaning method and device that is able to clean multiple needles at one time and more rapidly. There is a further need in the art for an injection needle cleaning device adapted to allow various cleaning fluids to be forced through the injection needle.

### BRIEF SUMMARY OF THE INVENTION

The present invention, in one embodiment, is a device for cleaning a plurality of injection needles having a hollow tubular body of a generally constant outer diameter, a proximal opening, and a distal opening. The device includes a housing defining a manifold and having a plurality of corresponding openings through a top and a bottom surface. The openings have a diameter roughly equal to or slightly larger than the needle diameter. The device further includes a high-pressure air source coupled to the housing and in fluid communication with the manifold.

The present invention, in another embodiment, is a method of cleaning a plurality of injection needles having a hollow body of a generally constant outer diameter, a proximal opening, and a distal opening. In this embodiment, the method includes providing a housing a housing defining a manifold, the housing having a plurality of corresponding openings through a top and a bottom surface, the openings having a diameter roughly equal to the needle diameter. The needles are inserted into the housing, until the proximal openings are located fully within the manifold. Pressurized air is directed into the manifold and through the needles. The needles are removed from the housing.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a schematic view of an injection needle cleaning device according to one embodiment of the present invention.

FIG. 2 is a perspective view of a portion of the injection needle cleaning device shown in FIG. 1 according to one embodiment of the present invention.

FIG. 3 is a sectional view of a cleaning manifold according to one embodiment of the present invention.

### DETAILED DESCRIPTION

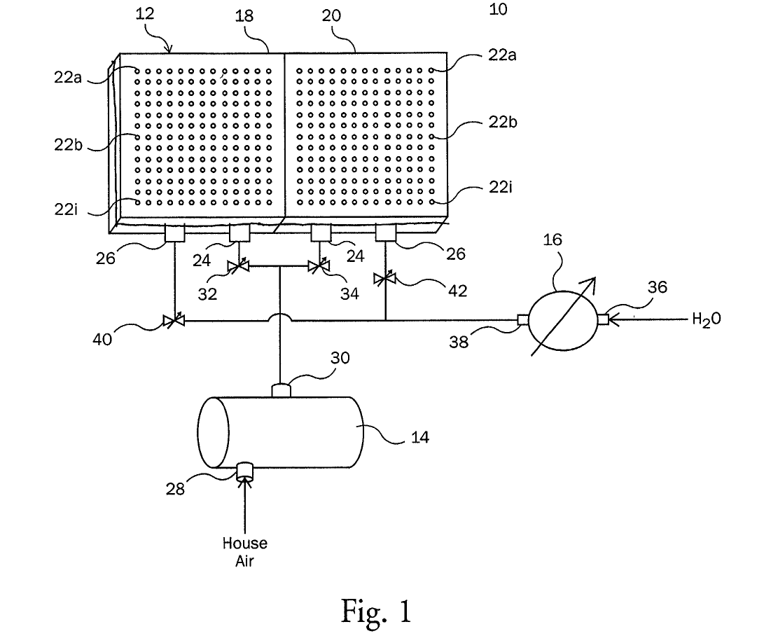

FIG. 1 shows a schematic view of an injection needle cleaning system 10 according to one embodiment of the present invention. As shown in FIG. 1, the injection needle cleaning system 10 includes a housing 12, an air reservoir 14, and a pump 16. As further shown in FIG. 1, in one embodiment, the housing 12 includes a first section 18 and a second section 20. Each of the sections 18, 20 includes a plurality of needle openings, 22a-22i. Each of the sections 18, 20 also includes an air inlet 24 and a water inlet 26. In one embodiment, the housing 12 is made from a USDA-approved nylon.

The air reservoir 14 includes an inlet 28 and an outlet 30. The air inlet 28 is connected in one embodiment to house air, and the outlet 30 is connected to the air inlets 24 on the housing 12. The air reservoir 14 is coupled to the sections 18, 20 of the housing 12 via a first valve 32 and a second valve 34, respectively. The valves 32 and 34 may be of any type known to one skilled in the art.

The fluid pump 16 includes an inlet 36 and an outlet 38. The inlet 36 is connected to a water supply and the outlet 38 is connected to the water inlet 26 of the sections 18, 20 of the housing 12 via a pair of valves 40 and 42, respectively. The valves 40, 42 may be of any type known in the art and operate to control the pressure drop between the fluid pump 16 and the housing 12. In one embodiment, the water supply includes a sanitizing agent to create a sanitizing solution. In one embodiment the sanitizing agent is an organic acid, such as acetic or lactic acid.

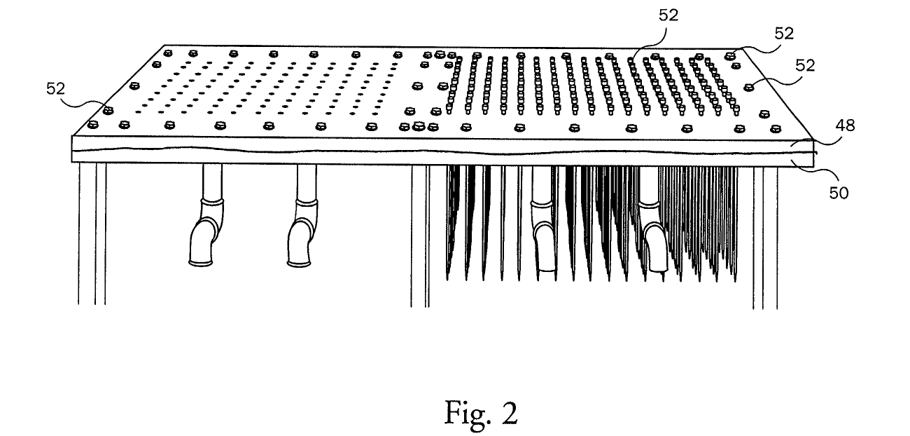

FIG. 2 shows a perspective view of the fluid manifold 12. As shown in FIG. 2, the fluid manifold 12 includes a top portion 48 and a bottom portion 50 coupled together by a plurality of fasteners 52. In one embodiment, the fluid manifold 12 further includes a gasket (not shown) between the top portion 48 and the bottom portion 50 that acts to ensure a sealed mating between the two portions 48, 50. As shown in FIG. 2, the second section 20 is loaded with a plurality of needles 56 and is ready for cleaning.

The housing 12 includes a first section 18 and a second section 20 to allow one set of needles to be loaded into the housing 12 while a second set of needles is cleaned of contaminants. In another embodiment of the present invention, only one section is included in the housing 12.

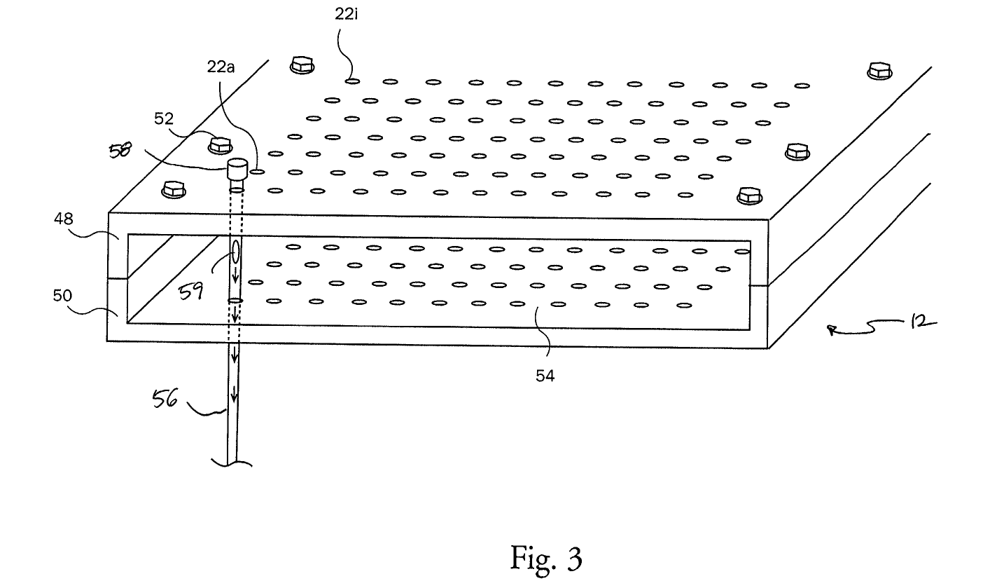

FIG. 3 shows a sectional view of the housing 12, according to one embodiment of the present invention. As shown in FIG. 3, the mated top portion 48 and bottom portion 50 define a hollow cavity or fluid manifold 54. The air inlets 24 and the water inlets 26 are in fluid communication with the manifold 54. Likewise, the plurality of needle holes 22a-22i are in fluid communication with the manifold 54. In the embodiment having multiple portions, each portion is fluidly sealed from another.

As shown in FIG. 3, the openings 22a through 22i extend through both the top portion 48 and the bottom portion 50, such that a needle 56 can be fully extended through the housing 12. As is generally shown, the openings 22a-22i are have a diameter sized to snugly accept the bore of the needle 56, thus preventing fluid leakage through the openings 22a-22i once the needle is loaded into the housing 12. In one embodiment of the present invention the openings 22 further include an O-ring (or other sealing device) to ensure that the opening is fluidly sealed upon insertion of the needle 56. In one embodiment of the present invention, the openings 22 include a valve, which moves from a sealed position to an open position when the needle 56 is inserted. This prevents fluid from escaping through any unused opening 22. Other embodiments of the present invention include a plug that may be used to seal unused openings 22.

As shown in FIG. 3, when fully inserted, a head 58 of the needle 56 abuts the top surface 48 of the housing 12. At this position, a proximal opening 60 of the needle 56 is located within the manifold 54 defined by the housing 12, such that any fluid directed into the manifold 54 will travel into the proximal opening 59 and out a distal opening at an opposite end of the needle 56.

During operation a full set of injection needles is inserted into the openings 22 of the housing 12, such that all openings 22 of one section are occupied by needles 56. The needles 56 are inserted such that the proximal opening 60 is located fully within the manifold 54. In the event that any opening 22 is not occupied by a needle 56, a plug is inserted to seal the unused opening. Next, an operator directs the cleaning air through the needles 56, by opening the valve 32. In one embodiment, the operator also directs water or a sanitizing solution through the needles 56, by opening the valve 40. Opening of the valve 32 or 40 causes air or water (or sanitizing fluid) to flow into the manifold 54. Fluid in the manifold 54 then flows out through the proximal openings 59 of the needles 56. In one embodiment, air is directed through the needles 56 for about fifteen to about thirty seconds. In another embodiment, up to about five gallons of water or water plus sanitizing agent is directed through the needles 56. In another embodiment, short boosts of air are injected while the water is being injected to enhance the cleaning operation. The amount and duration of fluid injection may vary depending upon the size and number of needles 56 being cleaned and the degree of contamination of the needles 56.

In one embodiment, a second operator loads a second set of injection needles 56 into the openings 22 of a second section of the housing, while the first operator performs the cleaning of the needles 56 in the first section. After the cleaning operation is completed, the operator removes the needles 56 from the housing.

Although the present invention has been described with reference to preferred embodiments, persons skilled in the art will recognize that changes may be made in form and detail without departing from the spirit and scope of the invention.

We claim:

1. A device for cleaning a plurality of injection needles having a hollow tubular body of a generally constant outer diameter, a proximal opening, and a distal opening, the device comprising:
a housing defining a manifold, the housing having a plurality of corresponding openings through a top and a bottom surface, the openings having a diameter roughly equal to the needle diameter; and
a high-pressure air source coupled to the housing and in fluid communication with the manifold.

2. The device of claim 1 further comprising a pressurized water source coupled to the housing and in fluid communication with the manifold.

3. The device of claim 1 wherein the housing contains a first section defining a first manifold and a second section defining a second manifold, the first and second manifolds fluidly sealed from each other.

4. The device of claim 3 wherein the high-pressure air source is coupled to both the first manifold and the second manifold.

5. The device of claim 1 wherein the openings include a seal adapted to generally seal the openings when the openings do not contain a needle such that the manifold remains fluidly sealed from the surrounding atmosphere.

6. The device of claim 1 wherein each of the openings includes an annular ring disposed around the perimeter of the opening, such that when the needle is inserted into the opening, the ring creates a fluid seal between the housing and the needle.

7. The device of claim 1 wherein the manifold has a height selected such that the proximal opening of the needle is located fully within the manifold.

8. The device of claim 1 wherein the housing includes a top portion and a bottom portion coupled together by a fastener, such that the top portion and bottom portion define the manifold.

9. The device of claim 8 wherein the housing further includes a gasket disposed between the top portion and the bottom portion to create a fluid seal therebetween.

10. A device for cleaning a plurality of injection needles having a hollow tubular body of a generally constant outer diameter, a proximal opening, and a distal opening, the device comprising:
a housing defining a first manifold and a second manifold, the housing having a plurality of corresponding openings through a top and a bottom surface, the openings having a diameter roughly equal to the needle diameter;
a high-pressure air source coupled to the housing and in fluid communication with the first and second manifolds; and
a pressurized water source coupled to the housing and in fluid communication with the first and second manifolds.

11. The device of claim 10 wherein the openings include a seal adapted to generally seal the openings when the openings do not contain a needle such that the manifold remains fluidly sealed from the surrounding atmosphere.

12. The device of claim 10 wherein each of the openings includes an annular ring disposed around the perimeter of the opening, such that when the needle is inserted into the opening, the ring creates a fluid seal between the housing and the needle.

13. The device of claim 10 further comprising first and second valves located between the air source and the housing for regulating the flow of air into the first and second manifolds.

14. The device of claim 10 wherein the housing includes a top portion and a bottom portion coupled together by a fastener, such that the top portion and bottom portion define the manifold.

15. The device of claim 14 wherein the housing further includes a gasket disposed between the top portion and the bottom portion to create a fluid seal therebetween.

16. A method of cleaning a plurality of injection needles having a hollow body of a generally constant outer diameter, a proximal opening, and a distal opening, the method comprising:
providing a housing defining a manifold, the housing having a plurality of corresponding openings through a top and a bottom surface, the openings having a diameter roughly equal to the needle diameter
inserting the needles into the housing, until the proximal openings are located fully within the manifold;
directing pressurized air into the manifold and through the needles; and
removing the needles from the housing.

17. The method of claim 16 further comprising blocking any openings not containing one of the plurality of needles to prevent fluid from passing through the opening.

18. The method of claim 16 further comprising directing pressurized water into the manifold and through the hollow body of the needles.

19. The method of claim 16 further comprising directing a sanitizing solution into the manifold and through the hollow body of the needles.
